(19) United States
(12) Patent Application Publication
(10) Pub. No.: US 2009/0262963 A1
(43) Pub. Date: Oct. 22, 2009

(54) AUDIO REPRODUCTION APPARATUS

(75) Inventors: Shinichi Inoue, Saitama (JP); Kazunobu Kubota, Saitama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/396,683

(22) Filed: Mar. 3, 2009

(30) Foreign Application Priority Data
Apr. 16, 2008 (JP) 2008-106917

(51) Int. Cl. H04R 5/02

(52) U.S. Cl. 381/302

(57) ABSTRACT

An audio reproduction apparatus for a vehicle wherein: a first speaker is installed on the right-hand side of a center position in front of a listener sitting on a right-side seat whereas a second speaker is installed on the left-hand side thereof; a third speaker is installed on the right-hand side of a center position in front of a listener sitting on a left-side seat and on the left-hand side of the second speaker whereas a fourth speaker is installed on the left-hand side of the center position in front of the listener; an audio signal of a right channel is supplied to the first and second speakers; an audio signal of a left channel is supplied to the third and fourth speakers; and low and intermediate frequency components of a sum of the audio signal of the right channel and the left channel are supplied to a fifth speaker.

### BACKGROUND OF THE INVENTION

1. Field of the Invention

The present invention relates to an audio reproduction apparatus used particularly as an audio reproduction apparatus mounted on a car.

2. Description of the Related Art

In the case of the stereo audio reproduction apparatus in related art mounted on a car, a left speaker L and a right speaker R are embedded on the inner sides of the left and right doors respectively as shown in diagrams of FIG. 7. In addition, a woofer W for reproducing heavy and low sounds is installed behind a rear seat. In the following description, as a typical configuration, the car has a right-side front seat on which a listener 1F sits and a left-side front seat on which a listener 2F sits. In the following description, the listener 1F is referred to as the driver and the right-side front seat is referred to as a driver seat whereas the listener 2F is referred to as a front passenger and the left-side front seat is referred to as a front passenger seat. On top of that, the car also has a right-side rear seat on which a rear passenger 1R sits and a left-side rear seat on which a rear passenger 2R sits.

In the figure, the driver 1F is denoted by a black circle whereas the front passenger 2F is denoted by a double circle ◯. In order to position a sound image 3 at a location in close proximity to the front center of the driver 1F, it is necessary to increase the sound pressure of the left speaker L to a level higher than the level of the sound pressure of the right speaker R. As a result, to the front passenger 2F sitting on the front passenger seat, the stereo audio reproduction apparatus in related art raises a problem that a sound image 3 is positioned in the periphery of the left speaker L and good stereo audio reproduction is thus impossible.

Conversely, as shown in diagrams of FIG. 8, in order to position a sound image 3 at a location in close proximity to the front center of the front passenger 2F, it is necessary to increase the sound pressure of the right speaker R to a level higher than the level of the sound pressure of the left speaker L. As a result, to the driver 1F sitting on the driver seat, there is raised a problem that a sound image 3 is positioned in the periphery of the right speaker R and good stereo audio reproduction is thus impossible.

In order to solve the problems described above, the speakers L and R are installed on the left and right-hand sides of typically the center of a dashboard as shown in diagrams of FIG. 9 symmetrically with respect to the center of the dashboard right in front of the driver 1F and the front passenger 2F. It is to be noted that the dashboard located beneath the front window means a board, which is directly facing the driver seat and the front passenger seat, and inner components mounted on the board. The speakers L and R generate equal sound pressures and reproduce audio signal of the left and right channels respectively. A sound image 3 is formed at about the center between the speakers L and R. Thus, the sound image 3 is located at a position shifted a little bit toward the inner side of the vehicle from the positions right in front of the driver 1F and the front passenger 2F. As a result, stereo audio reproduction good for both the driver and front passenger seats is possible.

In actuality, a variety of components are installed on the dashboard. The components installed on the dashboard include a handle, meters, a glove compartment and the air outlets of an air-conditioner. It is thus difficult to install speakers which each normally have a diameter of about 12 cm. Taking the easiness of installing the speakers into consideration, each of the speakers is divided into smaller speakers. That is to say, the use of a total of four speakers is conceivable.

As shown in a diagram of FIG. 10, speakers DL and DR are installed respectively on the left and right-hand sides of a center of the center position right in front of the driver 1F symmetrically with respect to the center position right in front of the driver 1F. By the same token, speakers PL and PR are installed respectively on the left and right-hand sides of a center of the center position right in front of the front passenger 2F symmetrically with respect to the center position right in front of the front passenger 2F. The same right-channel signal is supplied to the speakers DR and PR whereas the same left-channel signal is supplied to the speakers DL and PL.

In the case of this speaker layout, as shown in a diagram of FIG. 11, a sound source Rch of a synthesized right channel is created at a center position between the speakers DR and PR whereas a sound source Lch of a synthesized left channel is created at a center position between the speakers DL and PL. Since the distance between the synthesized sound sources Rch and Lch is short, the horizontal speaker location spread is not sufficient. Thus, the speaker layout raises a problem that the driver 1F, the front passenger 2F or both do not have a sufficient stereo feeling.

In addition, as shown in a diagram of FIG. 12 to the left-side rear passenger 2R sitting on the rear seat on the left-hand side, the distances to the speakers become longer so that the distance between the synthesized sound sources Rch and Lch becomes even shorter. Thus, the hope for the sufficient stereo feeling is small. The same problem is raised to the right-side rear passenger 1R sitting on the rear seat on the right-hand side.

Each of Japanese Patent Laid-open No. Sho 64-29200 and Japanese Patent Laid-open No. 2007-324907 (herein after referred to as Patent Documents 1 and 2, respectively) disclosed the layout of four speakers each installed at a position in front of the driver and the front passenger in related art.

### SUMMARY OF THE INVENTION

An audio reproduction apparatus provided for a car as described in Patent Document 1 is provided with a pair of center speakers L′ and R′ installed at the center position between the speakers L and R in related art shown in the diagrams of FIGS. 7 and 8. A left-channel signal is supplied to the center speaker L′ whereas a right-channel signal is supplied to the center speaker R′. Left-channel sounds generated by the center speaker L′ can be heard by only at the driver seat whereas right-channel sounds generated by the center speaker R′ can be heard by only at the front-passenger seat. With regard to the driver seat, a sound image of the left channel is created in conjunction with the left speaker L by adjusting the phase of the left-channel signal as a phase relative to the center speaker L′. With regard to the front-passenger seat, on the other hand, a sound image of the right channel is created in conjunction with the right speaker R by adjusting the phase of the right-channel signal as a phase relative to the center speaker R′. That is to say, the separation of sounds into the driver and front-passenger seats each serving as individual seats on the right and left-hand sides is adjusted by making use of auxiliary channels separated away from each other as channels of the center speakers L′ and R′. The speaker layout described in Patent Document 1 raises problems that a high degree of separation of the center speakers L′ and R′ from each other is required and the size of each of the center speakers L′ and R′ increases.

In an audio reproduction apparatus provided for a car as described in Patent Document 2, an R-channel signal having the normal phase is supplied to one of two speakers of the R channel whereas an R-channel signal having a phase opposite to the normal phase is supplied the other speaker of the R channel. By the same token, an L-channel signal having the normal phase is supplied to one of two speakers of the L channel whereas an L-channel signal having a phase opposite to the normal phase is supplied to the other speaker of the L channel. Thus, a wide-stereo feeling can be obtained. In the audio reproduction apparatus provided for a car as described in Patent Document 2, two speakers are installed right in front of the driver seat whereas two speakers are installed right in front of the front-passenger seat. As described before, however, car members such as the handle and meters are provided on the dashboard at locations right in front of the driver seat. Thus, in actuality, it is difficult to install the two speakers right in front of the driver seat.

It is thus desired for the present invention to provide an audio reproduction apparatus which is easy to install in a car and capable of giving a feeling of a speaker location spread.

In order to solve the problems described above, the present invention provides an audio reproduction apparatus for a vehicle wherein:

a first speaker is installed on the right-hand side of the center position in front of a listener sitting on the right-side seat of the vehicle whereas a second speaker is installed on the left-hand side of the center position in front of the listener sitting on the right-side seat of the vehicle;

a third speaker is installed on the right-hand side of the center position in front of a listener sitting on the left-side seat of the vehicle and on the left-hand side of the second speaker whereas a fourth speaker is installed on the left-hand side of the center position in front of the listener sitting on the left-side seat of the vehicle;

an audio signal of a right channel is supplied to the first and second speakers;

an audio signal of a left channel is supplied to the third and fourth speakers; and

low and intermediate frequency components of a sum signal obtained as a result of adding the audio signal of the right channel to the audio signal of the left channel are supplied to a fifth speaker.

It is desirable to supply intermediate and high frequency components of the audio signal of the right channel to the first and second speakers, supply intermediate and high frequency components of the audio signal of the left channel to the third and fourth speakers and supply the low and intermediate frequency components of the sum signal to the fifth speaker.

It is desirable to carry out correlation reduction processing to reduce correlations between the low and intermediate frequency components supplied to the fifth speaker and the audio signal of the right channel as well as correlations between the low and intermediate frequency components supplied to the fifth speaker and the audio signal of the left channel.

The first to fifth speakers are installed on the dashboard or embedded in the dashboard. The fifth speaker is provided at about the center position of the dashboard.

The audio reproduction apparatus further has a sixth speaker to which the low frequency components of the sum signal are supplied.

In accordance with the present invention, the four speakers DR, PR, DL and PL are laid out in the right-to-left order. Thus, a sound source of a synthesized L (left) channel is positioned at about the center between the speakers DL and PL whereas a sound source of a synthesized R (right) channel is positioned at about the center between the speakers DR and PR. As a result, a listener sitting on the driver seat or the front-passenger seat can enjoy stereo audio reproduction providing a feeling of a speaker location spread. In addition, the feeling of the speaker location spread can be sustained at the rear seats. On top of that, by installing a speaker M for reproducing low and intermediate frequency components, stereo audio reproduction having a broad frequency range can be carried out even if each of the four speakers used for reproducing intermediate and high frequency components has a small size.

### BRIEF DESCRIPTION OF THE DRAWINGS

These and other features of the present invention will become clear from the following description of the preferred embodiment given with reference to the accompanying diagrams, in which:

FIG. 1 is a rough diagram showing a layout of speakers in an embodiment of the present invention;

FIG. 2 is a rough diagram showing typical concrete installations of the speakers in the embodiment of the present invention;

FIG. 3 is a block diagram showing the embodiment of the present invention;

FIG. 4 is a rough diagram showing a typical division of a frequency band in the embodiment of the present invention;

FIG. 5 is an explanatory rough diagram to be referred to in description of stereo audio reproduction in the embodiment of the present invention for a front passenger sitting on a front-passenger seat;

FIG. 6 is an explanatory rough diagram to be referred to in description of stereo audio reproduction in the embodiment of the present invention for a rear passenger sitting on a rear-passenger seat;

FIG. 7 is an explanatory rough diagram to be referred to in description of a typical problem raised by the audio reproduction apparatus in related art;

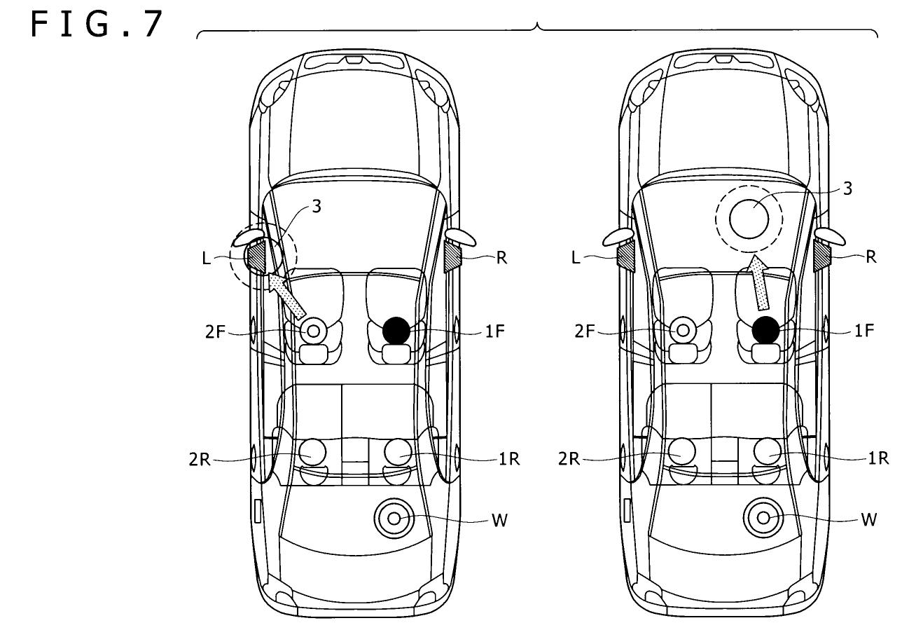

FIG. 8 is an explanatory rough diagram to be referred to in description of another typical problem raised by the audio reproduction apparatus in related art;

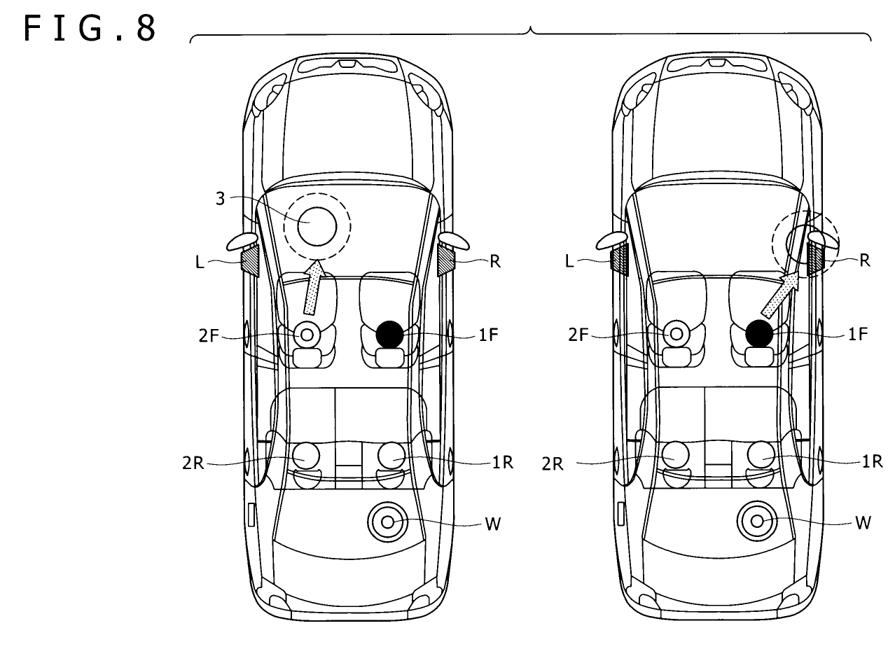

FIG. 9 is an explanatory rough diagram to be referred to in description of a further typical problem raised by the audio reproduction apparatus in related art;

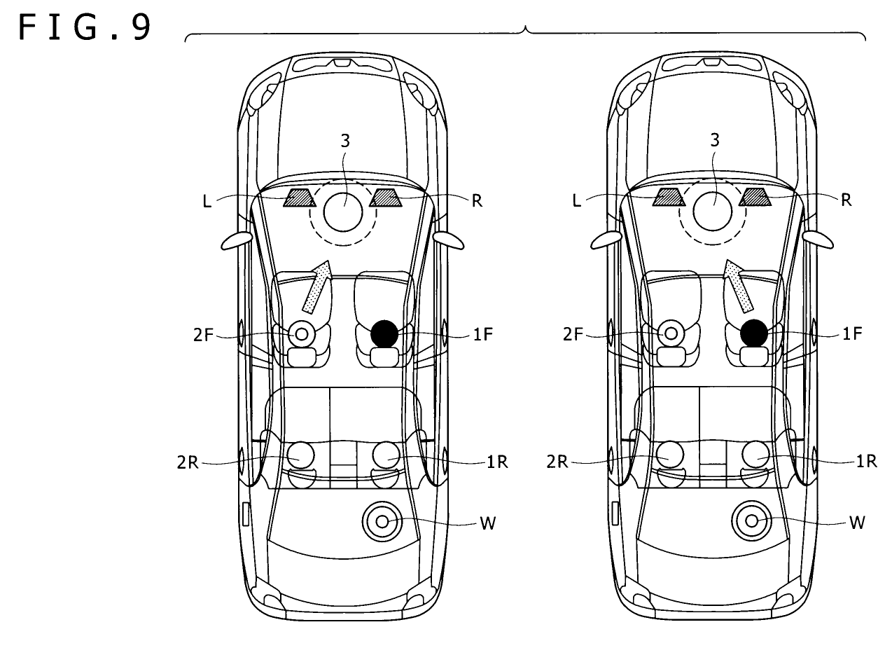

FIG. 10 is an explanatory rough diagram to be referred to in description of a typical layout of speakers in the audio reproduction apparatus in related art;

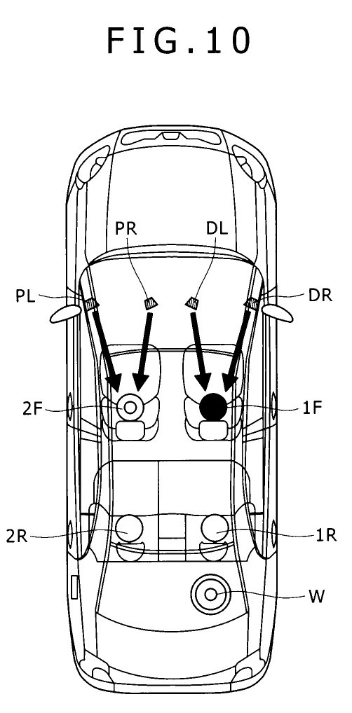

FIG. 11 is an explanatory rough diagram to be referred to in description of a still further typical problem raised by the audio reproduction apparatus in related art; and

FIG. 12 is an explanatory rough diagram to be referred to in description of a further typical problem raised by the audio reproduction apparatus in related art.

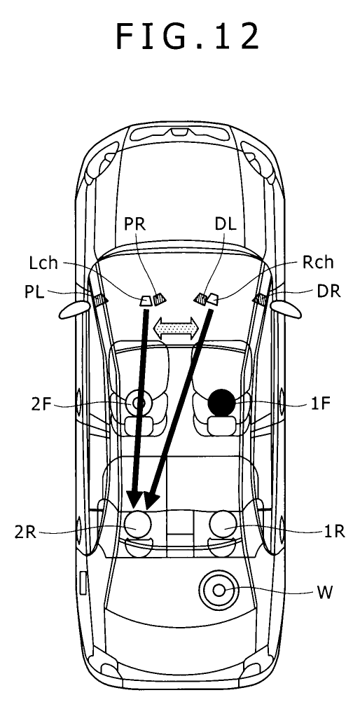

### DETAILED DESCRIPTION OF THE PREFERRED EMBODIMENT

An embodiment of the present invention is explained by referring to diagrams as follows. It is to be noted that the embodiment to be described below is no more than a preferred concrete implementation of the present invention and subjected to a variety of restrictions which are technologically desirable. However, the scope of the present invention is by no means limited to the preferred embodiment unless a particular restriction imposed on the present invention is deliberately specified in the following description.

An embodiment of the present invention is explained as follows. Relations associating the embodiment with the range of claims of this patent specification are described as follows:

a first speaker DR is installed on the right-hand side of the center position in front of the driver 1F sitting on the driver seat of a vehicle whereas a second speaker PR is installed on the left-hand side of the center position in front of the driver 1F sitting on the driver seat of the vehicle;

a third speaker DL is installed on the right-hand side of the center position in front of the front passenger 2F sitting on the front-passenger seat of the vehicle and on the left-hand side of the second speaker PR whereas a fourth speaker PL is installed on the left-hand side of the center position in front of the front passenger 2F sitting on the front-passenger seat of the vehicle;

an audio signal of a right channel is supplied to the first and second speakers DR and PR;

an audio signal of a left channel is supplied to the third and fourth speakers DL and PL; and

low and intermediate frequency components of a sum signal obtained as a result of adding the audio signal of the right channel to the audio signal of the left channel are supplied to a fifth speaker M which serves as a sub-woofer.

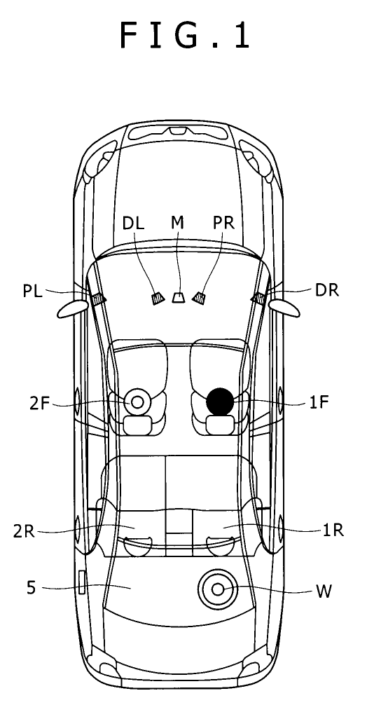

As shown in a diagram of FIG. 1, in a 4-door sedan taken as a typical vehicle, the first speaker DR serving as a driver right-channel speaker DR is installed on the right-hand side of the center position in front of the driver 1F sitting on the driver seat of the vehicle whereas the second speaker PR serving as a front-passenger right-channel speaker PR is installed on the left-hand side of the center position in front of the driver 1F sitting on the driver seat of the vehicle. In the diagram, the driver 1F is denoted by a black circle . Intermediate and high frequency components of the audio signal of the right channel are supplied to the speakers DR and PR.

By the same token, the third speaker DL serving as a driver left-channel speaker DL is installed on the right-hand side of the center position in front of the front passenger 2F sitting on the front-passenger seat of the vehicle and on the left-hand side of the speaker PR whereas the fourth speaker PL serving as a front-passenger left-channel speaker PL is installed on the left-hand side of the center position in front of the front passenger 2F sitting on the front-passenger seat of the vehicle. In the diagram, the front passenger 2F is denoted by a double circle ◯. Intermediate and high frequency components of the audio signal of the left channel are supplied to the speakers DL and PL.

Each of the speakers DR, PR, DL and PL is a speaker for reproducing intermediate and high frequency components. In an operation to reproduce intermediate and high frequency components, a directivity characteristic clearly changes in accordance with the position of the listener in comparison with an operation to reproduce low frequency components. That is to say, in an operation to reproduce intermediate and high frequency components, an effect of an angular shift of the listener from the right forward axial direction of a speaker unit is larger than that of the operation to reproduce low frequency components. Thus, the orientation of each of the speakers DR and DL is set so that a sound originating from each of the speakers DR and DL is directed to the driver 1F. By the same token, the orientation of each of the speakers PR and PL is set so that a sound originating from each of the speakers PR and PL is directed to the front passenger 2F.

In addition, the sub-woofer M is installed at an approximately middle position between the speakers PR and DL which are provided at about the center (of the dashboard). Low and intermediate frequency components of a sum signal, which is a monaural signal obtained as a result of adding the audio signal of the right channel to the audio signal of the left channel, are supplied the sub-woofer M. A woofer W is installed on a rear deck 5 of the car. Low frequency components of the sum signal, which is a monaural signal obtained as a result of adding the audio signal of the right channel to the audio signal of the left channel as described above, are supplied to the woofer W.

The woofer W is component for reproducing heavy and low sounds and, thus, it is not necessary to worry about the directivity characteristic. For example, the woofer W is installed on the rear deck 5 so that the forward axial direction of the woofer W is oriented in the upward direction. On the other hand, the sub-woofer M reproduces sounds in a frequency band affected by the directivity characteristic of the sub-woofer M with a relatively high degree. As will be described later, however, signal processing is carried out on a signal to be supplied to the sub-woofer M so that sounds generated by the sub-woofer M are not affected by the directivity characteristic of the sub-woofer M.

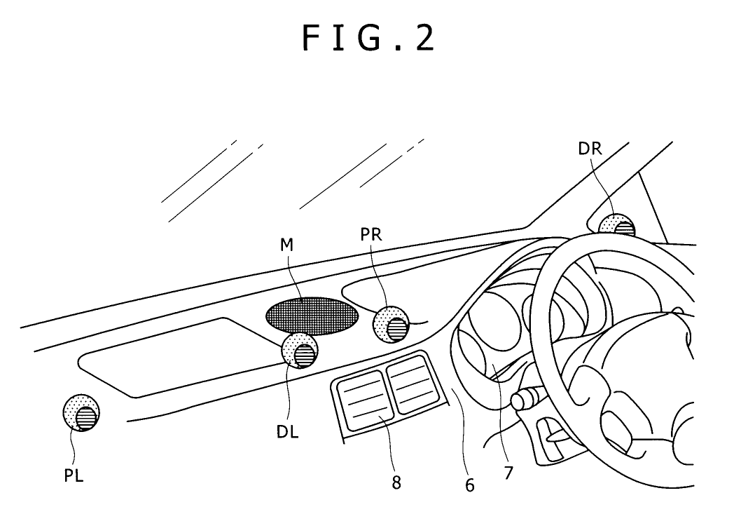

As shown in a diagram of FIG. 2, the speakers DR, DL, PR and PL as well as the sub-woofer M are installed on the dashboard 6. On the dashboard 6, components such as meters 7 and air-conditioner air outlets 8 are also provided. The speaker DR on the right-hand side is installed in the vicinity of an A pillar of the driver seat whereas the speaker PL on the left-hand side is installed in the vicinity of an A pillar of the front-passenger seat. Each of the speakers DR, DL, PR and PL is a compact dynamic-type speaker having about the same size as a golf ball with a diameter of approximately 3 cm. It is relatively easy to install each of the speakers DR, DL, PR and PL on the dashboard 6. In the typical layout shown in the diagram of FIG. 2, each of the speakers DR, DL, PR and PL is installed by placing it on the dashboard 6. It is to be noted, however, that each of the speakers DR, DL, PR and PL can also be installed as a speaker embedded in the dashboard 6.

The sub-woofer M is provided at about the center of the dashboard 6 in such an orientation that sounds are generated by the sub-woofer M in the upward direction. The sub-woofer M is typically a dynamic-type speaker having a face diameter of about 12 cm. On the other hand, the woofer W is typically a dynamic-type speaker having a face diameter of about 24 cm. The woofer W can be a speaker having the shape of a box installed on the rear deck 5. It is to be noted that the face diameters of the speakers are typical and the dynamic type of the sub-woofer M and the woofer W are also typical as well. That is to say, speakers other than the speakers described above can also be used.

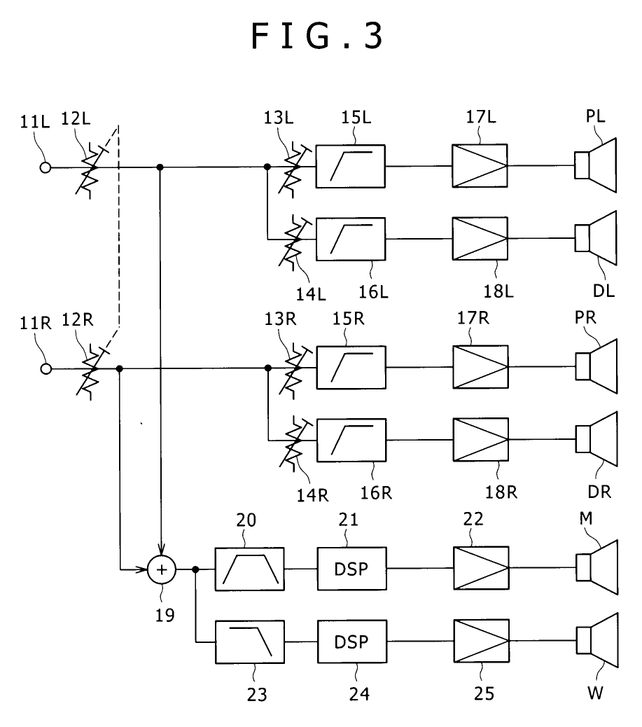

In the embodiment of the present invention, audio signals are supplied to the speakers as shown in a diagram of FIG. 3. The L (left) channel signal of a stereo audio signal is supplied to an input terminal 11L. By the same token, the R (right) channel signal of the stereo audio signal is supplied to an input terminal 11R. The stereo audio signal itself is supplied by a signal source such as a CD (Compact Disk) player or a receiver.

The L channel signal supplied to the input terminal 11L is forwarded to a high pass filter 15L by way of a volume adjuster 12L and a balance adjuster 13L and to a high pass filter 16L by way of the volume adjuster 12L and a balance adjuster 14L. Intermediate and high frequency components output as signals by the high pass filter 15L and the high pass filter 16L are supplied to the speaker PL and the speaker DL respectively by way of amplifiers 17L and 18L respectively.

By the same token, the R channel signal supplied to the input terminal 11R is forwarded to a high pass filter 15R by way of a volume adjuster 12R and a balance adjuster 13R and to a high pass filter 16R by way of the volume adjuster 12R and a balance adjuster 14R. Intermediate and high frequency components output as signals by the high pass filter 15R and the high pass filter 16R are supplied to the speaker PR and the speaker DR respectively by way of amplifiers 17R and 18R respectively.

The L channel signal output by the volume adjuster 12L and the R channel signal output by the volume adjuster 12R are supplied to an adder 19 for computing the sum of the L and R channel signals. The adder 19 outputs a monaural signal referred to as a sum signal representing the sum of the L and R channel signals. The sum signal is supplied to a DSP (Digital Signal Processor) 21 by way of a band pass filter 20. The DSP 21 generates low and intermediate frequency signals which are then supplied to the sub-woofer M by way of an amplifier 22.

By the same token, the sum signal output by the adder 19 is supplied to a DSP 24 by way of a low pass filter 23. The DSP 24 generates low frequency signals which are then supplied to the woofer W by way of an amplifier 25.

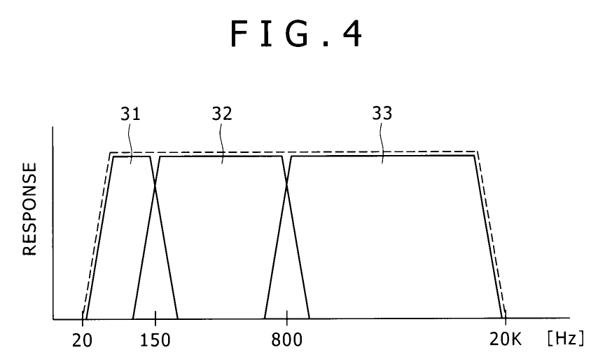

The high pass filters 15L, 15R, 16L and 16R, the band pass filter 20 as well as the low pass filter 23 divide the band of the input audio signal into a low frequency band 31, an intermediate frequency band 32 and a high frequency band 33. In a diagram of FIG. 4, the band of the input audio signal is the band typically from a frequency of 20 Hz to a frequency of 20 KHz as shown by a dashed line. The low frequency band 31, the intermediate frequency band 32 and the high frequency band 33 partially overlap each other to a certain degree. For example, the upper crossover frequency of the low pass filter 23 having the low frequency band 31 is 150 Hz and the lower crossover frequency of the band pass filter 20 having the intermediate frequency band 32 is also 150 Hz. By the same token, the upper crossover frequency of the band pass filter 20 is 800 Hz and the lower crossover frequency of each of the high pass filters 15L, 15R, 16L and 16R each having the high frequency band 33 is also 800 Hz. A properly set range of ±50 HZ to ±100 Hz centered at a lower crossover frequency of a filter can be regarded as the lowest frequency range of the filter. By the same token, a properly set range of ±50 HZ to ±100 Hz centered at an upper crossover frequency of a filter can be regarded as the highest frequency range of the filter. The low frequency components cited earlier are signal components selected by the low pass filter 23 which has the upper crossover frequency of 150 Hz. The low and intermediate frequency components cited earlier are signal components selected by the band pass filter 20 which has the lower crossover frequency of 150 Hz and the upper crossover frequency of 800 Hz. The intermediate and high frequency components cited earlier are signal components selected by each of the high band filters 15L, 15R, 16L and 16R which each have the lower crossover frequency of 800 Hz.

The DSP 21 is a section configured to carry out a correlation reduction process on a signal to be supplied to the sub-woofer M whereas the DSP 24 is a section configured to carry out a correlation reduction process on a signal to be supplied to the woofer W. To put it in detail, the DSP 21 is a section configured to carry out a process to reduce the correlations between intermediate and high frequency signals to be supplied to the speakers PL, PR, DL and DR provided for the intermediate and high frequency signals and low and intermediate frequency signals to be supplied to the sub-woofer M provided for the low and intermediate frequency signals. By the same token, the DSP 24 is a section configured to carry out a process to reduce the correlations between intermediate and high frequency signals to be supplied to the speakers PL, PR, DL and DR and low frequency signals to be supplied to the woofer W provided for the low frequency signals. By carrying out the correlation reduction processes described above, it is possible to prevent a sound image formed by the speakers PL, PR, DL and DR from being put in a state of disorder by sound images formed by the sub-woofer M and the woofer W. It is to be noted that, since the frequencies of signals supplied to the woofer W are very low, the correlation reduction process does not have to be carried out on the low frequency signals supplied to the woofer W.

As the correlation reduction processes to be carried out by the DSPs 21 and 24, it is possible to perform a process proposed by the applicant of this application for a patent as disclosed in Japanese Patent Laid-open No. 2007-2888677. To put it concretely, in accordance with the proposed process, an IIR (Infinite Impulse Response) digital filter to serve as a correlation reduction filter is constructed on the basis of a DSP and only the phase of a signal is changed in accordance with the frequency without varying the sound pressure in order to reduce the correlations.

In addition, a delay circuit also constructed on the basis of the DSP is connected to the phase reduction filter. The delay circuit delays low and intermediate frequency sounds generated by the sub-woofer M provided for the low and intermediate frequency signals and the woofer W provided for the low frequency signals from the intermediate and high frequency sound image formed by the speakers PL, PR, DL and DR provided for the intermediate and high frequency signals. By delaying the low and intermediate frequency sounds generated by the sub-woofer M and the woofer W from the intermediate and high frequency sound image formed by the speakers PL, PR, DL and DR, the listener is capable of recognizing a sound as if the sound source were placed at a position separated away from the listener in the direction toward the speakers PL, PR, DL and DR which form the intermediate and high frequency sound image recognized first by the listener. By carrying out the correlation reduction processes, it becomes more difficult for the listener to recognize that sound sources exist at the positions of the sub-woofer M and the woofer W.

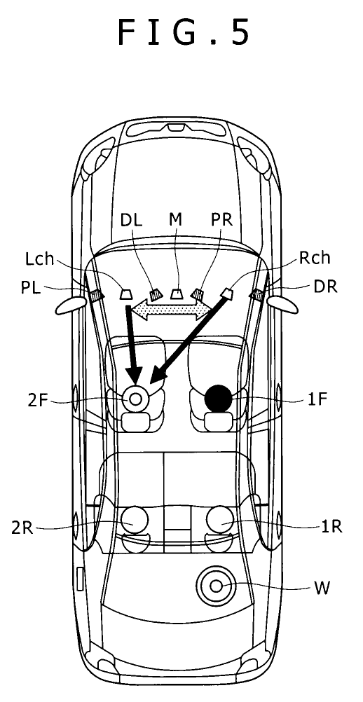

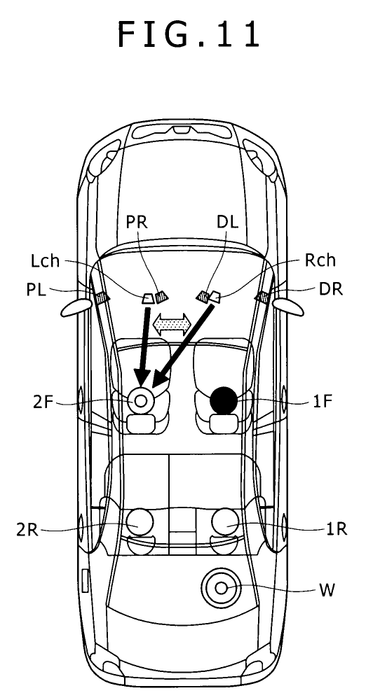

As shown in a diagram of FIG. 5, in the case of a speaker layout according to the embodiment of the present invention, a sound source Rch of a synthesized right channel is created at a middle position between the speakers DR and PR whereas a sound source Lch of a synthesized left channel is created at a middle position between the speakers DL and PL. Since the distance between the synthesized sound sources Rch and Lch is greater than that of the speaker layout explained previously by referring to the diagram of FIG. 11, the left-to-right spread of the speaker layout shown in the diagram of FIG. 5 is sufficient. Thus, both the driver 1F and the front passenger 2F are capable of obtaining an enough stereo feeling.

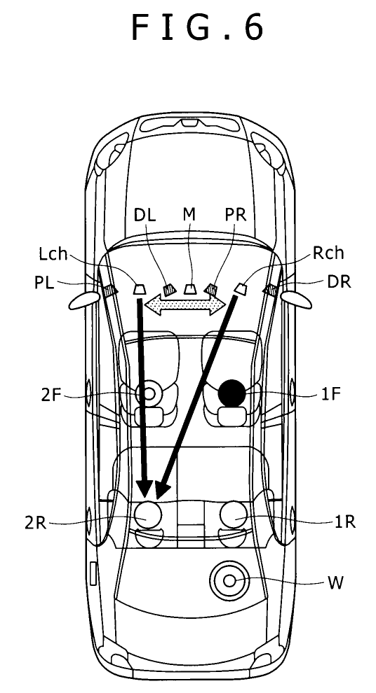

In addition, since the distance between the synthesized sound sources Rch and Lch is greater than that of the speaker layout explained previously by referring to the diagram of FIG. 11 as described above, the hope of the left-side rear passenger 2R, who is sitting on a left-side rear seat far away from the speakers PL, PR, DL and DR as shown in a diagram of FIG. 6, for the sufficient stereo feeling can be prevented from becoming small. By the same token, since the distance between the synthesized sound sources Rch and Lch is greater than that of the speaker layout explained previously by referring to the diagram of FIG. 11, the hope of the right-side rear passenger 1R, who is sitting on a right-side rear seat far away from the speakers PL, PR, DL and DR as shown in a diagram of FIG. 6, for the sufficient stereo feeling can be prevented from becoming small. It is thus possible to carry out an audio reproduction operation that provides a stereo feeling.

The scope of the present invention is by no means limited to the embodiment described above. That is to say, it is possible to create a variety of modifications based on the technological concepts of the present invention. For example, the sub-woofer M provided for reproduction of low and intermediate frequency signals can be installed at a position other than the center of the dashboard or installed beneath the dashboard.

The present application contains subject matter related to that disclosed in Japanese Priority Patent Application JP 2008-106917 filed in the Japan Patent Office on Apr. 16, 2008, the entire content of which is hereby incorporated by reference.

It should be understood by those skilled in the art that various modifications, combinations, sub-combinations and alternations may occur depending on design requirements and other factors insofar as they are within the scope of the appended claims or the equivalent thereof.

What is claimed is:

1. An audio reproduction apparatus for a vehicle wherein:
a first speaker is installed on the right-hand side of a center position in front of a listener sitting on a right-side seat of said vehicle whereas a second speaker is installed on the left-hand side of said center position in front of said listener sitting on said right-side seat of said vehicle;
a third speaker is installed on the right-hand side of a center position in front of a listener sitting on a left-side seat of said vehicle and on the left-hand side of said second speaker whereas a fourth speaker is installed on the left-hand side of said center position in front of said listener sitting on said left-side seat of said vehicle;
an audio signal of a right channel is supplied to said first and second speakers;
an audio signal of a left channel is supplied to said third and fourth speakers; and
low and intermediate frequency components of a sum signal obtained as a result of adding said audio signal of said right channel to said audio signal of said left channel are supplied to a fifth speaker.

2. The audio reproduction apparatus according to claim 1 wherein intermediate and high frequency components of said audio signal of said right channel are supplied to said first and second speakers, intermediate and high frequency components of said audio signal of said left channel are supplied to said third and fourth speakers whereas said low and intermediate frequency components of said sum signal are supplied to said fifth speaker.

3. The audio reproduction apparatus according to claim 2 wherein correlation reduction processing is carried out in order to reduce correlations between said low and intermediate frequency components supplied to said fifth speaker and said audio signal of said right channel as well as correlations between said low and intermediate frequency components supplied to said fifth speaker and said audio signal of said left channel.

4. The audio reproduction apparatus according to claim 1 wherein said first to fifth speakers are installed on a dashboard.

5. The audio reproduction apparatus according to claim 4 wherein said fifth speaker is provided at about the center position of said dashboard.

6. The audio reproduction apparatus according to claim 1 wherein said first to fifth speakers are embedded in a dashboard.

7. The audio reproduction apparatus according to claim 6 wherein said fifth speaker is provided at about the center position of said dashboard.

8. The audio reproduction apparatus according to claim 1, said audio reproduction apparatus further having a sixth speaker to which low frequency components of said sum signal are supplied.

9. The audio reproduction apparatus according to claim 1 wherein:
said first and third speakers are set so that sounds are generated by said first and third speakers in a direction toward said listener sitting on said right-side seat of said vehicle; and
said second and fourth speakers are set so that sounds are generated by said second and fourth speakers in a direction toward said listener sitting on said left-side seat of said vehicle.
